(19) United States
(12) Patent Application Publication
(10) Pub. No.: US 2009/0144158 A1
(43) Pub. Date: Jun. 4, 2009

(54) System And Method For Enabling Viewing Of Documents Not In HTML Format

(76) Inventors: Brent R. Matzelle, Philadelphia, PA (US); Christopher D. Cera, Philadelphia, PA (US); Christopher A. Dailey, Wernersville, PA (US); Gregory J. Bright, Ardmore, PA (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 12/326,989

(22) Filed: Dec. 3, 2008

Related U.S. Application Data
(60) Provisional application No. 60/992,019, filed on Dec. 3, 2007.

(51) Int. Cl. G06F 17/00; G06Q 30/00

(52) U.S. Cl. 705/14; 715/205

(57) ABSTRACT

A system and method for enabling viewing of non-HTML content. A content provider receives a request to view non-HTML content from a user and forwards JavaScript code to the user. The content provider sends the non-HTML content over a network to a document hosting service. The document hosting service receives the content, converts it into at least one image and assigns a URL to the at least one image. The JavaScript generates the URL at the user's computer. The document hosting service receives the request for the URL from the user and forwards the at least one image to the user.

This application claims priority to U.S. Patent application Ser. No. 60/992,019 entitled “Vuzit an online web based document viewer with an array of administrative tools”, filed Dec. 3, 2007, the entirety of which is hereby incorporated by reference.

### BACKGROUND OF THE INVENTION

1. Field of the Invention

This application relates to a system and method for enabling viewing of documents not written in HTML without requiring the use of an application in addition to a browser.

2. Description of the Related Art

Referring to FIG. 1, there is shown a system 20 for viewing documents accessible over the Internet in accordance with the prior art. As shown, a user 34 may use a computer 36 including a browser program 38 to access the Internet 28 and view a web page 24 stored on a web server 26. Web pages 24 are typically written in hypertext markup language (HTML) and browser 38 is designed to read such language and display page 24 on computer 36. Web page 24 may also include a link 42 to additional content 22 that is not written in HTML. For example, page 24 may include a link 42 to an ADOBE PDF (portable document format) file, a MICROSOFT WORD file, POWERPOINT presentation, etc. Browser 38 typically cannot process such non-HTML content. For example, if non-HTML content 22 is a PDF file, browser 38 receives a file type flag indicating the file is non-HTML, and computer 36 may be re-directed to another web server 30. Web server 30 includes an application 32 that may be downloaded and run on computer 36 as application 40. If non-HTML content 22 is a file such as a MICROSOFT WORD file or a MICROSOFT EXCEL file, user 34 may need to purchase the requisite application 40 to view such a file. Once application 40 is installed on computer 36, when browser 38 receives a MIME content type flag for non-HTML content, browser 38 accesses application 40 to render non-HTML content 22.

Prior art systems are problematic for many reasons. When application 40 is loaded, the focus of the user's display is affected as are the actions of the user. The content owner loses the ability to control and track the user's actions. As the user leaves the content owner's website to move to the website owned by application 32, there is a loss of the content owner's presence (e.g. branding, navigation options, etc.) which disorients the user and leads to workflow difficulties.

Moreover, application 40 must be maintained. For example, in a large organization, an information technology department must maintain many copies of application 40, each stored on a distinct user's computer. Moreover, any updates for application 40 must be performed, again for each individual user's computer. Still further, when application 40 is installed, other programs may be included in application 40 that user 34 may not need or desire and which may compromise the security of computer 36 such as viruses or other malware.

### SUMMARY OF THE INVENTION

One embodiment of the invention is a method for enabling viewing of non-HTML content. The method comprises receiving non-HTML content from a network at a first processor and forwarding the non-HTML content to a second processor. The method further comprises converting the non-HTML content at the second processor into at least one image, assigning a URL to the at least one image at the second processor, receiving a request for the URL from a user at the first processor, and forwarding the at least one image to the user.

Another embodiment of the invention is a system for enabling viewing of non-HTML content. The system comprises a network and a first processor in communication with the network, the first processor effective to receive from the network, non-HTML content. The system further comprises a second processor in communication with the first processor, the second processor effective to receive the non-HTML content from the first processor, the second processor effective to convert the non-HTML content into at least one image and to assign a URL to the at least one image. The first processor is further effective to receive a request for the URL from a user and to forward the at least one image to the users.

### BRIEF DESCRIPTION OF THE DRAWINGS

The drawings constitute a part of the specification and include exemplary embodiments of the present invention and illustrate various objects and features thereof.

FIG. 1 is a system drawing of a system for viewing non-HTML content in accordance with the prior art.

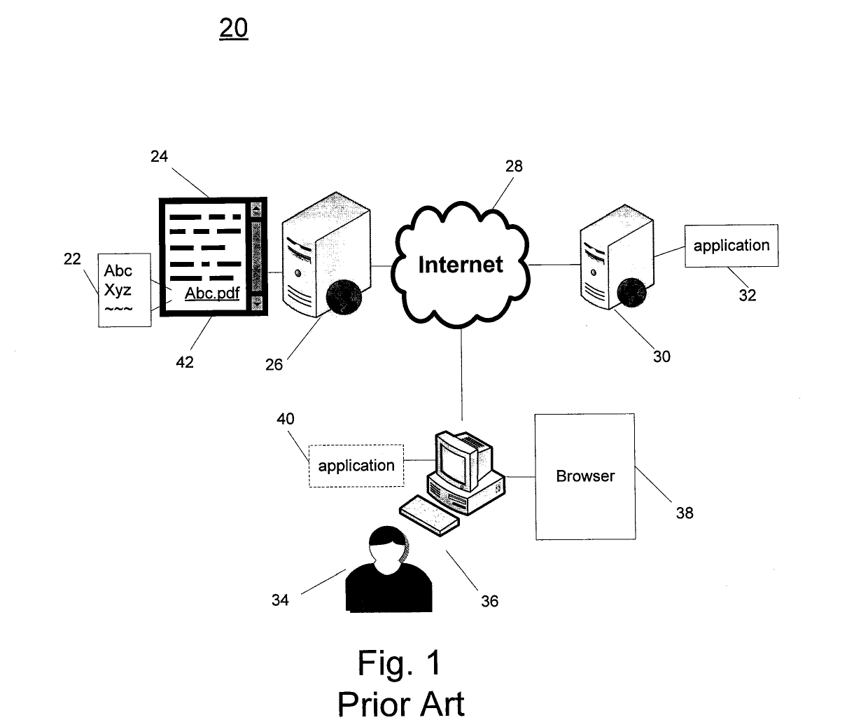

FIG. 2 is a system drawing of a system for viewing non-HTML content in accordance with an embodiment of the invention.

FIG. 3 is a schematic drawing of a data structure which could be used in accordance with an embodiment of the invention.

FIG. 4 is flow chart of a process which could be performed in accordance with an embodiment of the invention.

FIG. 5 is a flow chart of a process which could be performed in accordance with an embodiment of the invention.

### DETAILED DESCRIPTION OF THE PREFERRED EMBODIMENT(S)

Various embodiments of the invention are described hereinafter with reference to the figures. Elements of like structures or function are represented with like reference numerals throughout the figures. The figures are only intended to facilitate the description of the invention or as a limitation on the scope of the invention. In addition, an aspect described in conjunction with a particular embodiment of the invention is not necessarily limited to that embodiment and can be practiced in conjunction with any other embodiments of the invention.

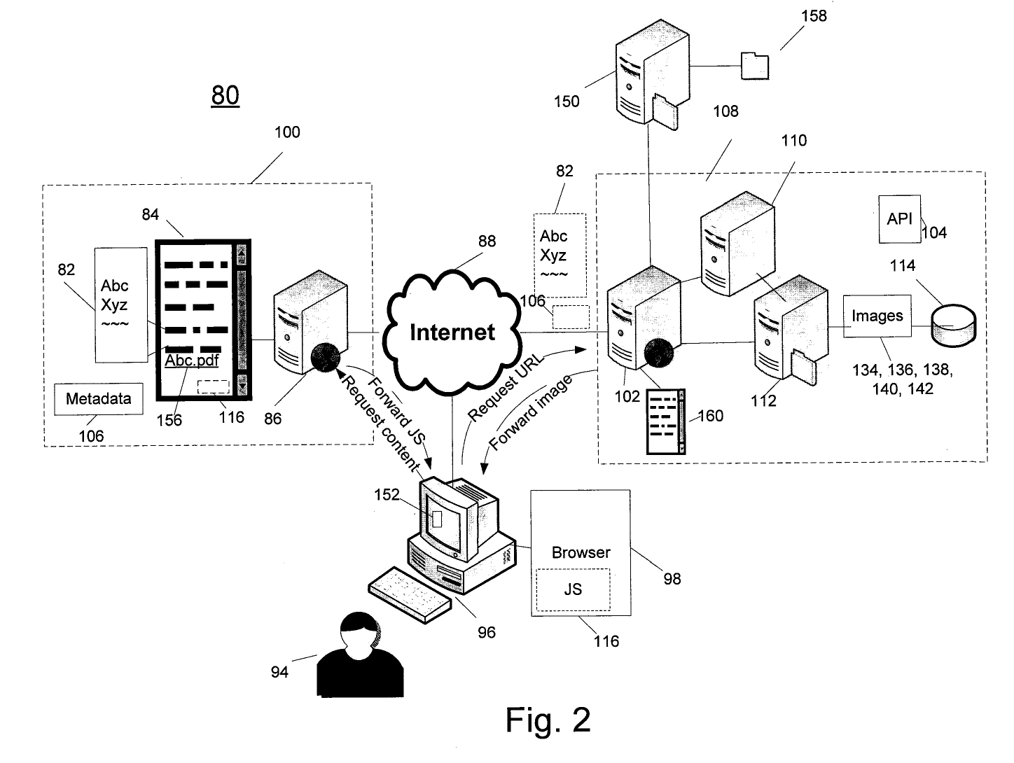

Referring to FIG. 2, there is shown a system 80 in accordance with an embodiment of the invention. As shown, a user 94 may use a computer 96 including a browser program 98 to access a network such as the Internet 88 and view a web page 84 stored on a web server 86 in communication with Internet 88 and owned by a content provider 100. Web pages 86 are typically written in HTML and browser 98 can read such language and display page 84 on computer 96. Web page 84 may also include a link 156 to additional content 82 that is not written in HTML. For example, page 84 may include a link 156 to a PDF file, a WORD file, POWERPOINT presentation, etc. When user 94 requests to view non-HTML content 82, by for example clicking on link 156, a piece of code 116 such as JavaScript, ADOBE FLASH or a Cascading Stylesheet in page 84 is then forwarded to user's computer 96. The purpose of this code is explained below.

To enable viewing of non-HTML content 82 by user 94, content provider 100 may receive an application program interface (API) 104 from a document hosting service 108. API 104 may allow content provider 100 to batch together pieces of non-HTML content 82 and generate metadata 106 relating to non-HTML content 82. Metadata 106 may be used to help render and control the distribution by non-HTML content 82 as discussed in more detail below. Content provider 100 may forward non-HTML content 82, either prior to or after a request to view content 82 by user 94, and metadata 106 to a web server 102 in communication with Internet 88 and owned by document hosting service 108. Document hosting service 108 converts non-HTML content so that it may be rendered using browser 98 as discussed below. Non-HTML content 82 may also be uploaded by another user to web server 102 or a user may provide document hosting service 108 a URL pointing to a document of interest.

### Examples of metadata 106 that may be provided by content provider 100 include

1) Title of content

2) Display width of the content

3) Display height of the content

4) Number of pages in the content

5) Physical size of the content in bytes

6) Name of the submitter of the content

7) IP Address of the submitter of the content

8) Creator of the content

9) Producer of the content

10) Resultant image file formats such as JPEG or PNG

11) Unique identification number of the content

12) Number of content impressions

13) Date the content was created

14) Date the content was modified

15) A unique identifier given by the content provider's web server to the content (e.g. the HTTP 1.1 ETag as defined by RFC 2616)

16) An indicator identifying if the content can be edited by a user

17) An indicator identifying whether the content can be copied

18) An indicator identifying whether the content can be printed

19) Zoom levels that are available to a user. For example, 3 zoom levels and a thumbnail may be identified.

Some of the metadata 106 may affect how fast a document may be streamed to a user. For example, higher quality and large size documents may take longer to stream than lower quality, smaller documents. Other metadata 106 may include what page is first displayed (e.g. page 5 first), what is loaded in a full screen command, default zoom level, etc.

Non-HTML content 82 is received by web server 102. Web server 102 may be written in the Rails web application framework and may be running a Representational State Transfer (REST) web service. Non-HTML content 82 is forwarded to a document conversion server 110. An authentication step may be performed to ensure that content owner 100 has a valid subscription with document hosting service 108. For example, web server 102 can look to see if a URL corresponding to web page 84 is in a list of subscriber URLs. Document conversion server 110 performs operations on non-HTML content 82. For example, conversion server 110 creates a bounding box for each word in non-HTML content 82. Such a bounding box defines the location (e.g. x and y coordinates), width and height of the smallest bounding rectangle that can surround each word in non-HTML content 82. The bounding box allows user 94 to navigate, highlight, find, copy and paste words in non-HTML content as is explained below.

Conversion server 110 generates an ID number for non-HTML content 82 and creates a directory, hosted by a file management server 112, with the same name as the ID number. Conversion server 110 then converts non-HTML content 82 into a plurality of images 134, 136, 138, 140, 142 each in a format readable by browser 98 or computer 96, such as JPEG (joint pictures expert group) or PNG (portable network graphics). For example, the following formats may be converted into JPEG or PNG format:

ADOBE PDF: pdf

MICROSOFT OFFICE: doc, docx, rtf, xls, xlsx, ppt, pptx

Images: png, jpg, gif, tif, bmp, ppm, xpm

Vector Graphics: eps, ras

Text Files: txt

OpenOffice: odt, odf, ott, odg, odp, stw, sxw, std, sxd, sti, sxi, sxc

StarOffice: sda, sdd, sdw, vor

OpenDocument: otg, stp, ods, pts

For example, if 3 zoom levels and a thumbnail are defined by metadata 106, images are created for each page at each zoom level for non-HTML content 82. Metadata 106 may include the size of each zoom level (e.g. 640×480 pixels, etc.) which is also used by conversion server 110 in generating images 134, 136, 138, 140 and 142.

For example, non-HTML content 82 with the address XYZ.com/res.pdf may be forwarded to web server 102 and document conversion server 110 and assigned an ID number 1234. Document conversion server 110 may check a database 114 hosted by a file server 112 to see if document 1234 has been stored and converted by document hosting service 108. If not, document 1234 is forwarded to document conversion server 110 for converting. As discussed above, during converting, each page of non-HTML content 82 is converted to a corresponding image for the original content and for each defined zoom level in metadata 106 to create new images in a format readable by computer 96 such as JPEG or PNG formats. The Rmagick Ruby library may interface with ImageMagick and/or the VeryPDF PDF to Image Converter COM Component library to produce such images. For each zoom level, a distinct image is generated and a URL is assigned and stored in database 114.

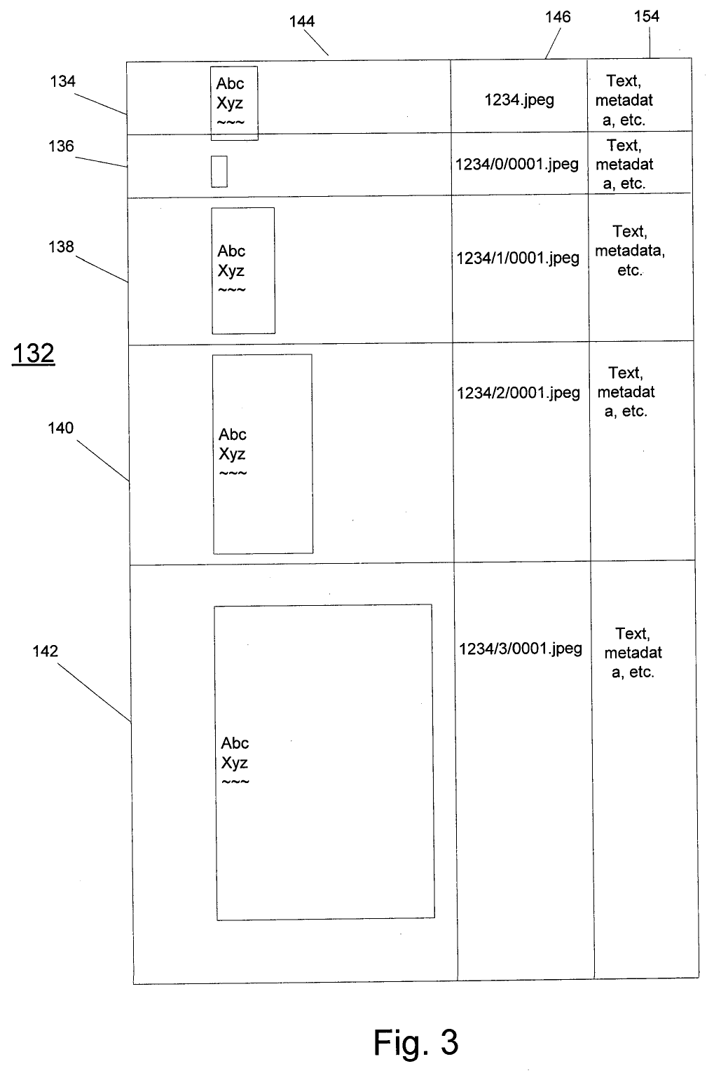

Continuing with the example, for document 1234, five images may be generated for four zoom levels (e.g. three zoom levels in addition to original non-HTML content 82 and a thumbnail). Referring momentarily to FIG. 3, there is shown a data structure 132 which could be used in accordance with an embodiment of the invention. Data structure 132 may include an image column 144 and a file name column 146. An image 134 of non-HTML content 82 is shown in the first row of image column 144. Document conversion server 110 (FIG. 2) generated images 136, 138, 140 and 142 for zoom different zoom levels of original content 82 defined by metadata 106. A hierarchical tree address is generated for each image 136, 138, 140, 142 so that each image may be accessed directly through network 88 (FIG. 2). For example, image 136 may be a thumbnail representation of original non-HTML content 82 and is given a file name 1234/0/0001.jpeg where “1234” corresponds to the identifier for original non-HTML content 82, “0” corresponds to a thumbnail zoom, “0001” corresponds to a first page of the content, and “jpeg” corresponds to the JPEG format. This image could then be accessed by a request to network 88 for the URL, in hypertext transfer protocol format, “document_hosting_service.com/1234/0/0001/jpeg”.

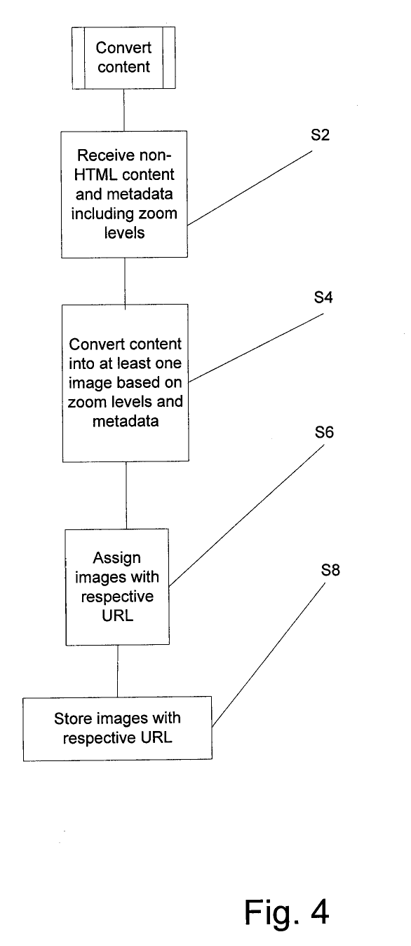

Referring momentarily to FIG. 4, there is shown a process for converting content in accordance with an embodiment of the invention. As shown, as a step S2, non-HTML content and metadata including zoom levels is received. At step S4, the content is converted into at least one of images based on the zoom levels and the metadata. For example the VeryPDF PDF to Image Converter Com Component could be used to convert the content. At step S6, URLs are assigned to the images. At step S8, the images are stored with respective URLs so that each image is individually accessible.

Referring again to FIG. 2, each page of original content 82 is also processed by document conversion server 110 to convert original content 82 into text. For example, Glyph and Cog's XpdfText PDF Text extraction tool or XpdfInfo tools may be used to extract text or metadata from original content 82. The text is stored in database 114 and may be used for searching of non-HTML content as discussed below.

Each piece of metadata 106 (e.g. name title, author etc.) and the text converted from non-HTML content 82 from multiple sources may be stored in database 114 with a pointer to relevant non-HTML content 82. For example, data structure 132 (FIG. 3) may include a column 154 with this data. Column 154 may be maintained for all non-HTML content 82 in database 114 so that searching of all non-HTML content 82 may be performed. For example, user 94 may issue a query to web server 102 relating to a keyword. Web server 102 may search database 114 for responses that satisfy the query. Those responses include pointers to certain regions defined by bounding boxes of images 134, 136, 138, 140 and 142 stored in database 114 and user 94 may be provided with those images.

As discussed above, when user 94 requests non-HTML content 82 by clicking on link 156, JavaScript 116 is forwarded to computer 96. Browser 98, along with JavaScript 116 communicates with web server 102. If non-HTML content 82 has not been processed by document conversion server 110, JavaScript 116 continues to communicate with web server 102 until non-HTML content 82 has been processed. As non-HTML content 82 and metadata 106 is processed by document conversion server 110, metadata 106 may be forwarded to computer 96 so that JavaScript 116 may begin rendering a viewer 152 inside web page 84 displayed to user 94. For example, the default zoom levels, total number of pages, etc. may be forwarded to browser 98 and JavaScript 116 may generate viewer 152 indicating the total number of pages, number of zoom levels, etc.

When document conversion server 110 has completed processing of non-HTML content 82, JavaScript 116 may request non-HTML content 82. For example, JavaScript 116 may generate a request for non-HTML content at a particular zoom level. As discussed above, images corresponding to each zoom level are stored in database 114 with distinct assigned URLs. JavaScript 116 generates the specific URL corresponding to the image of desired zoom level and forwards the specific URL to network 88 and document hosting service 108. The URL may be generated using the convention discussed above with reference to FIG. 3, i.e. the URL may be the document hosting server's name, followed by a document identifier assigned by the document hosting service, followed by a number indicating the zoom level, and followed by a number indicating the page number. The image corresponding to the requested page and zoom level of non-HTML content 82 is streamed to browser 98 using, for example, a HTTP communication stream. Images of adjacent pages adjacent to the requested page may also be streamed. For example, if JavaScript 116 requests page 10, web server 102 may stream page 10 and then stream page 9, then 11, then 8, then 12, etc. Requests by JavaScript 116 may use AJAX (asynchronous JavaScript and XML) commands. JavaScript 116 generates the request for the specific URL based on link 156 and metadata 106 indicating default display parameters.

As each image is stored in an address defined by a hierarchical tree, each request from JavaScript 116 first goes through web server 102. This means that analytical information may be generated by web server 102 relating to what images a user downloaded, for how long, at what zoom level, number of impressions, number of unique impressions, time on an image, time on a region of an image (e.g. by zoom level), percentage of single page visits (sometimes called the bounce rate), referrer information, etc. For example, the time between requests by JavaScript 116 may be used to determine how long user 94 spent on each image. Certain information stored and transmitted by browser 98 may also be used in analytical information.

User 94 may perform all standard viewing operations on non-HTML content 82 such as zooming in and out defined by zoom levels in metadata 106, scrolling forward and backward through a document, printing, saving, etc. User 94 may select text and copy the text to browser 98 or to a clipboard. For example, the generated bounding box and text generated from images 134, 136, 138, 140 and 142 discussed above may be transmitted to browser 98 along with the images. When a user highlights a particular area in the image, a conventional two-dimensional geometric range query may be performed to determine the closest bounding box and text near the user's cursor. That text may then be copied or pasted to a clipboard using application programmer interfaces (APIs) available in conventional browsers. Similarly, user 94 may issue a “find” command to JavaScript 116 to search for desired text in images and have that text highlighted in its bounding box, using pointers discussed above, facilitating navigation. If allowed by metadata 106, JavaScript 116 may enable user 94 to annotate images 134, 136, 138, 140 and 142. For example, line drawing, circles, redactions in the form of black or white boxes, highlighting, underlining, etc. could all be enabled by JavaScript 116. User 94 may add text comments to images 134, 136, 138, 140 and 142. Any changes to images made by user 94 may be forwarded by JavaScript 116 to web server 102 and stored in database 114. For example, an annotated document file could be created with the extension 0001x.jpeg indicating that file 0001 was annotated by a user. Information indicating which user made the annotation may be stored. Other users may access the annotated document and add even further annotations or prior annotations may be hidden from a subsequent user's view.

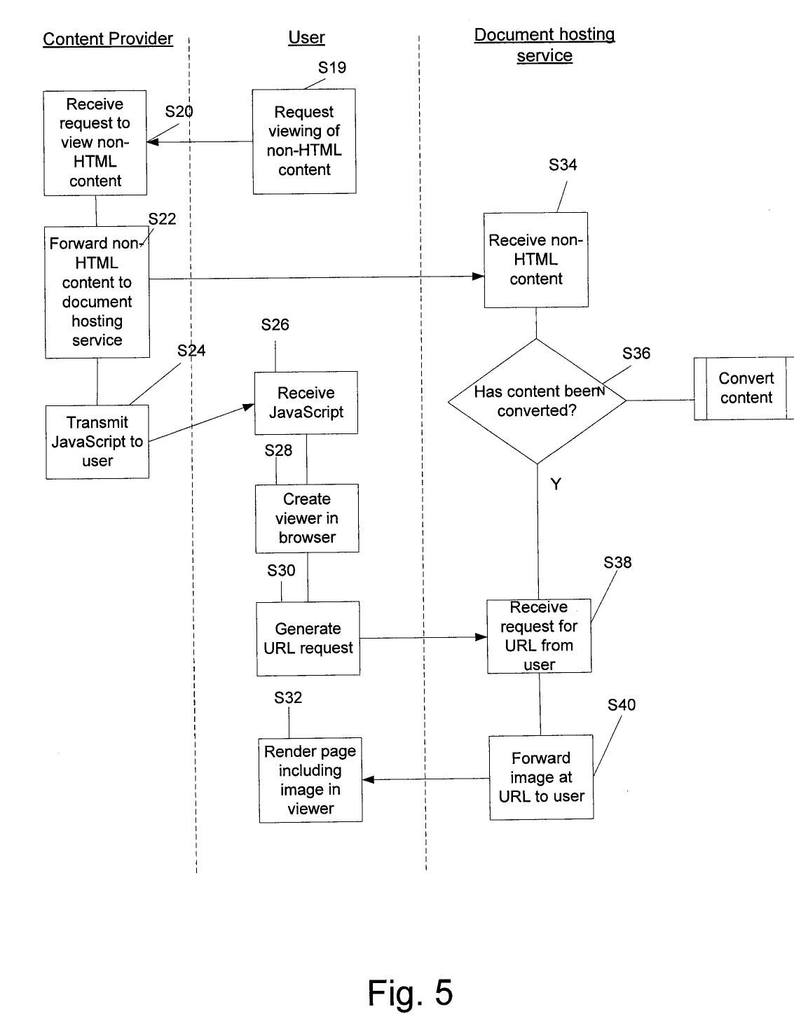

Referring to FIG. 5, there is shown a process which could be performed in accordance with an embodiment of the invention. The process in FIG. 5 could be performed using, for example, system 80 discussed above with reference to FIG. 2. As shown, at a step S119, a user may make a request to view non-HTML content. At a step S20, a content provider may receive the request to view non-HTML content. At step S22, the content provider forwards the non-HTML content to a document hosting service. At step S24, the content provider downloads JavaScript to the user. The JavaScript was given to content provider by the document hosting service.

At step S34, the document hosting service receives the non-HTML content. The document hosting service may also receive the non-HTML content from a user. At step S36, the document hosting service makes a query to determine whether the content has been converted. If the content has not been converted, the document hosting service converts the content using, for example, the process described above with reference to FIG. 4. If the content has been converted, control passes to step S38.

After step S24 when the content provider downloaded the JavaScript to the user, the user receives the JavaScript at step S26. At step S28, the JavaScript creates a viewer in a browser at the user's computer. At step S30, the JavaScript generates a request for a URL corresponding to the non-HTML content desired by the user. At step S38, the document hosting service receives the request for the URL from the user. At step S40, the document hosting service forwards the image at the URL to the user. At step S32, the JavaScript and browser at the user's computer renders a page including the desired image in a viewer.

Referring again to FIG. 2, as discussed above, each page of original content 82 may be converted into text. Advertisers may choose to purchase advertisements provided to users in conjunction with certain text. For example, when user 94 requests a particular page and zoom level, JavaScript 116 generates a corresponding URL. Web server 102 receives that URL and may look in database 114 (e.g., column 154 of data structure 132) to determine what text words are included in the image corresponding to that URL and what advertisers have paid to serve advertisements with those words. Web server 102 may then request an advertisement 158 from an advertising engine (such as GOOGLE ADWORDS) or ad server 150 and send it to browser 98. JavaScript 116 may then render viewer 152 including the advertisement on a bottom or other portion of viewer 152.

For each image stored in database 114, web server 102 may use a RUBY application to periodically scan the corresponding web page 84 to see if changes have been made to the source non-HTML content. For example, the ETags may be stored for web pages and if the ETag changes, then the RUBY application will know that the corresponding web page has changed.

As JavaScript 116 generates viewer 152 within a displayed web page, more than one viewer 152 may be active at any time. In this way, two documents may be viewed side by side in a single page rendered by a single browser or different sections of a single document may be viewed at the same time.

Content provider 100 may design link 156 associated with non-HTML content 82 so that when user 94 hovers over the link, JavaScript 116 requests an image from database 114 corresponding to the thumbnail for non-HTML content 82. In this way, user 94 may see a preview of non-HTML content 82 as, for example, a pop-up window.

Hyperlinks in non-HTML content 82, pointing to a URL, may be maintained in images 134, 136, 138, 140 and 142 such that clicking on the hyperlink causes a new browser window to open including the web page at the URL's address.

Content provider 100 may define certain regions in non-HTML content 82 that user 94 can view. Such definitions may be made in metadata 106. For example, content provider 100 may define pages, or regions of pages, that may be viewed by user 94 so that content provider 100 may highlight certain pertinent quotations in non-HTML content 82. In metadata 106, content provider 100 may request that each page or region of a page be assigned a unique URL so that content provider 100 can distribute URLs relating to individual pages or regions of a document.

If particular access control is defined in metadata 106, authentication of user 94 may be performed before allowing access to any images 134, 136, 138, 140, 142. For example, user 94 may only be allowed to view but not modify images. Such authentication may be through known methods such as through the use of a user name and password or through other HTTP basic authentication.

System 80 can keep track of a popularity of non-HTML content 82. For example, web server 102 can keep track of the content most requested by users. A web page 160 may be generated by web server 102 including the most “popular” content voted by users and respective titles, elapsed time since submission, number of pages in the content, and the number of impressions, etc. A “latest” section may be used in the web page to show the most recently uploaded documents along with elapsed time of submission, number of pages in the document and the number of impressions, etc. A user may similarly keep track of all the documents he has uploaded to web server 102 using, for example, browser 98 and/or JavaScript 116.

Metadata 106 may be used to define certain digital rights management properties for non-HTML content 82. For example metadata 106 may inform web server 102 not to stream certain portions (such as a particular page) of non-HTML content 82 to user 94. Alternatively, metadata 106 may inform web server 102 to only allow streaming of non-HTML content 82 into a cache of browser 98 so that user 94 has limited options on distributing non-HTML content 82. As metadata 106 may prevent non-HTML content from being downloaded, user 94 is prevented from, making modifications and/or redistributing the original content.

Thus, unlike prior art techniques, a small amount of JavaScript code may be transmitted to a user's browser, that code enables viewing of an unlimited number of formats—whereas the prior art could only handle one format per application downloaded. As no additional software needs to be installed on the user's computer 96, the user may view non-HTML content and stay on the content owner's web site and maintain that experience. There is less of a need for updates or a concern for viruses. A user can navigate through a document or switch zoom levels without having to reload the entire web page into a browser.

The invention has been described with reference to an embodiment that illustrates the principles of the invention and is not meant to limit the scope of the invention. Modifications and alterations may occur to others upon reading and understanding the preceding detailed description. It is intended that the scope of the invention be construed as including all modifications and alterations that may occur to others upon reading and understanding the preceding detailed description insofar as they come within the scope of the following claims or equivalents thereof. Various changes may be made without departing from the spirit and scope of the invention. For example, any of the described servers could be implanted as one or more processors. Processors could be combined into single processors or servers or distributed among a plurality of processors or servers.

What is claimed is:

1. A method for enabling viewing of non-HTML content, the method comprising:
receiving non-HTML content from a network at a first processor;
forwarding the non-HTML content to a second processor;
converting the non-HTML content at the second processor into at least one image;
assigning a URL to the at least one image at the second processor;
receiving a request for the URL from a user at the first processor; and
forwarding the at least one image to the user.

2. The method as recited in claim 1, wherein the first and second processors are distinct.

3. The method as recited in claim 1, wherein the receiving the non-HTML content includes receiving metadata about the non-HTML content.

4. The method as recited in claim 3, wherein the metadata includes at least one zoom level for the non-HTML content.

5. The method as recited in claim 4, further comprising:
generating at least one additional image corresponding to the at least one zoom level; and
assigning at least one additional URL to the at least one additional image.

6. The method as recited in claim 3, wherein the metadata includes digital rights management information for non-HTML content.

7. The method as recited in claim 1, wherein the image is in JPEG or PNG format.

8. The method as recited in claim 1, further comprising converting the non-HTML content into text.

9. The method as recited in claim 8, further comprising forwarding an advertisement to the user based on the text.

10. The method as recited in claim 1, further comprising generating analytical information relating to the request for the URL.

11. The method as recited in claim 1, further comprising:
receiving a request for the non-HTML content at a third processor from the user; and
forwarding code from the third processor to the user; wherein
the code generates the request for the URL.

12. The method as recited in claim 11, wherein the first, second and third processors are distinct.

13. The method as recited in claim 11, wherein the receiving the non-HTML content includes receiving metadata about the non-HTML content.

14. The method as recited in claim 13, wherein the metadata includes at least one zoom level for the non-HTML content.

15. The method as recited in claim 14, further comprising:
generating at least one additional image corresponding to the at least one zoom level; and
assigning at least one additional URL to the at least one additional image.

16. The method as recited in claim 13, wherein the metadata includes digital rights management information for non-HTML content.

17. The method as recited in claim 11, wherein the image is in JPEG or PNG format.

18. The method as recited in claim 11, further comprising converting the non-HTML content into text.

19. The method as recited in claim 18, further comprising forwarding an advertisement to the user based on the text.

20. The method as recited in claim 11, further comprising generating analytical information regarding the receiving the request for the URL.

21. The method as recited in claim 20, further comprising generating a web page based on the analytical information.

22. The method as recited in claim 11, wherein the request for the URL is generated by the code.

23. The method as recited in claim 11, further comprising:
receiving a file from the user at the second processor, the file including an annotation made to the image by the user; and
storing the file.

24. A system for enabling viewing of non-HTML content, the system comprising:
a network;
a first processor in communication with the network, the first processor effective to receive from the network, non-HTML content; and
a second processor in communication with the first processor, the second processor effective to receive the non-HTML content from the first processor, the second processor effective to convert the non-HTML content into at least one image and to assign a URL to the at least one image; wherein
the first processor is further effective to receive a request for the URL from a user and to forward the at least one image to the user.
